(19) United States
(12) Patent Application Publication
(10) Pub. No.: US 2024/0267944 A1
(43) Pub. Date: Aug. 8, 2024

(54) FIRST MESSAGE REPETITION FOR MISSION CRITICAL USER EQUIPMENTS

(71) Applicant: Telefonaktiebolaget LM Ericsson (publ), Stockholm (SE)

(72) Inventors: Jingya LI, GÖTEBORG (SE); Zhipeng LIN, NANJING, Jiangsu (CN); Mats FOLKE, VÄLLINGBY (SE)

(73) Assignee: Telefonaktiebolaget LM Ericsson (publ), Stockholm (SE)

(21) Appl. No.: 18/567,757

(22) PCT Filed: May 30, 2022
(86) PCT No.: PCT/EP2022/064587

§ 371 Date: Dec. 7, 2023

(30) Foreign Application Priority Data
Jun. 7, 2021 (WO) PCT/CN2021/098658

(51) Int. Cl. H04W 74/00; H04W 74/0833

(52) U.S. Cl. CPC H04W 74/002; H04W 74/0833

(57) ABSTRACT

A method for configuring one or more user equipments (UEs) to repeatedly transmit a first message while a repetition condition is met is provided. The method comprises including in a second message a repetition parameter. The repetition parameter indicates that a UE receiving the second message including the repetition parameter is allowed to or must transmit the first message repeatedly while the repetition condition is met if one or more criteria are met. The method further comprises transmitting the second message.

### TECHNICAL FIELD

Disclosed are embodiments related to first message repetition for mission critical user equipments (UEs).

### BACKGROUND

### 1. New Radio (NR) Initial Access

Before a UE can properly communicate within a network, it must carry out cell search to find, synchronize, and identify a cell. Then, it can acquire basic system information and perform random access procedure to establish a connection to the cell.

### 1.1 NR Cell Search and System Information Acquisition

In NR, the combination of synchronization signals (SS) and physical broadcast channel (PBCH) is referred to as a SS/PBCH block (SSB). Similar to Long-Term Evolution (LTE), a pair of SS—primary synchronization signal (PSS) and secondary synchronization signal (SSS)—is periodically transmitted on downlink from each cell to allow a UE to initially access to the network. By detecting SS, a UE can obtain the physical cell identity, achieve downlink synchronization in both time and frequency, and acquire the timing for PBCH. PBCH carries the master information block (MIB) which contains minimum system information that a UE is needed to acquire system information block 1 (SIB 1). SIB1 carries the remaining minimum system information that is needed for a UE to be able to perform subsequent random-access procedure.

### 1.2 NR 4-Step Random Access Procedure

The 4-step random access produce (for initial access), also referred to as Type-1 random access procedure in 3GPP Technical Specification (TS) 38.213, is illustrated in FIG. 1. In step 1, a UE initiates the random-access procedure by transmitting in UL a random-access preamble (Msg 1) on a physical random-access channel (PRACH). After detecting the Msg1, in step 2, base station (BS) (e.g., gNB) may respond by transmitting in DL a random-access response (RAR) on a Physical Downlink Shared Channel (PDSCH) (Msg2). In step 3, after successfully decoding Msg2, UE continues the procedure by transmitting in UL a Physical Uplink Shared Channel (PUSCH) (Msg3) for terminal identification and Radio Resource Control (RRC) connection establishment request. In step 4 of the procedure, BS transmits in DL a PDSCH (Msg4) for contention resolution.

There can be cases where multiple UEs select the same random-access preamble and transmit the preamble on the same PRACH time/frequency resource. This preamble collision is called contention. One of the main purposes of applying step 3 and step 4 is to resolve such potential contention.

### 1.3 NR 2-Step Random Access Procedure

The 2-step random access produce (for initial access), also referred to as Type-2 random access procedure in TS 38.213, is illustrated in FIG. 2.

In the first step, UE sends a message A (msgA) including random access preamble together with higher layer data such as RRC connection request possibly with some small payload on PUSCH. After detecting the msgA, the network (e.g., BS) sends Random Access Response (RAR) (called msgB) including UE identifier assignment, timing advance information, and contention resolution message, etc.

### 2. NR Rel-15 PRACH Configuration

In NR, the time and frequency resource on which a random-access preamble (Msg 1) is transmitted is defined as a PRACH occasion.

The time resources and preamble format for the Msg1 transmission is configured by a PRACH configuration index, which indicates a row in a PRACH configuration table specified in TS 38.211—Tables 6.3.3.2-2, 6.3.3.2-3, 6.3.3.2-4 for FR1 paired spectrum, FR1 unpaired spectrum and FR2 with unpaired spectrum, respectively.

Part of the table 6.3.3.2-3 for FR1 unpaired spectrum for preamble format 0 is provided in Table 1 below. Table 1 shows PRACH configuration for preamble format 0 for FR1 unpaired spectrum. In table 1, the value of x indicates the PRACH configuration period in number of system frames. The value of y indicates the system frame within each PRACH configuration period on which the PRACH occasions are configured. For instance, if y is set to 0, then it means PRACH occasions only configured in the first frame of each PRACH configuration period. The values in the column “subframe number” tells on which subframes are configured with PRACH occasion. The values in the column “starting symbol” is the symbol index.

In case of Time Division Duplex (TDD), semi-statically configured Downlink (DL) parts and/or actually transmitted SSBs can override and invalidate some time-domain PRACH occasions defined in the PRACH configuration table. More specifically, PRACH occasions in the Uplink (UL) part are always valid, and a PRACH occasion within the X part is valid as long as it does not precede or collide with an SSB in the RACH slot and it is at least N symbols after the DL part and the last symbol of an SSB. N is 0 or 2 depending on PRACH format and subcarrier spacing.

TABLE 1
PRACH configuration for preamble format 0 for FRI unpaired spectrum

| | | | | | | | Nₜ^{RA, slot}, | |
|---|---|---|---|---|---|---|---|---|
| | | | | | | | number of | |
| | | | | | | | time-domain | |
| | | | | | | Number of | PRACH | |
| | | | | | | PRACH | occasions | |
| PRACH | | | | | | slots | within a | N_{dur}^{RA}, |
| Configuration | Preamble | n_{SFN} mod x = y | | Subframe | Starting | within a | PRACH | PRACH |
| Index | format | x | y | number | symbol | subframe | slot | duration |
| 0 | 0 | 16 | 1 | 9 | 0 | — | — | 0 |
| 1 | 0 | 8 | 1 | 9 | 0 | — | — | 0 |
| 2 | 0 | 4 | 1 | 9 | 0 | — | — | 0 |
| 3 | 0 | 2 | 0 | 9 | 0 | — | — | 0 |
| 4 | 0 | 2 | 1 | 9 | 0 | — | — | 0 |
| 5 | 0 | 2 | 0 | 4 | 0 | — | — | 0 |
| 6 | 0 | 2 | 1 | 4 | 0 | — | — | 0 |
| 7 | 0 | 1 | 0 | 9 | 0 | — | — | 0 |
| 8 | 0 | 1 | 0 | 8 | 0 | — | — | 0 |
| 9 | 0 | 1 | 0 | 7 | 0 | — | — | 0 |
| 10 | 0 | 1 | 0 | 6 | 0 | — | — | 0 |
| 11 | 0 | 1 | 0 | 5 | 0 | — | — | 0 |
| 12 | 0 | 1 | 0 | 4 | 0 | — | — | 0 |
| 13 | 0 | 1 | 0 | 3 | 0 | — | — | 0 |
| 14 | 0 | 1 | 0 | 2 | 0 | — | — | 0 |
| 15 | 0 | 1 | 0 | 1, 6 | 0 | | | 0 |
| 16 | 0 | 1 | 0 | 1, 6 | 7 | — | — | 0 |
| 17 | 0 | 1 | 0 | 4, 9 | 0 | — | — | 0 |
| 18 | 0 | 1 | 0 | 3, 8 | 0 | — | — | 0 |
| 19 | 0 | 1 | 0 | 2, 7 | 0 | — | — | 0 |
| 20 | 0 | 1 | 0 | 8, 9 | 0 | — | — | 0 |
| 21 | 0 | 1 | 0 | 4, 8, 9 | 0 | — | — | 0 |
| 22 | 0 | 1 | 0 | 3, 4, 9 | 0 | — | — | 0 |
| 23 | 0 | 1 | 0 | 7, 8, 9 | 0 | — | — | 0 |
| 24 | 0 | 1 | 0 | 3, 4, 8, 9 | 0 | — | — | 0 |
| 25 | 0 | 1 | 0 | 6, 7, 8, 9 | 0 | — | — | 0 |
| 26 | 0 | 1 | 0 | 1, 4, 6, 9 | 0 | — | — | 0 |
| 27 | 0 | 1 | 0 | 1, 3, 5, 7, 9 | 0 | — | — | 0 |

In the frequency domain, NR supports multiple frequency-multiplexed PRACH occasions on the same time-domain PRACH occasion. This is mainly motivated by the support of analog beam sweeping in NR such that the PRACH occasions associated to one SSB are configured at the same time instance but different frequency locations. The starting position in the frequency is indicated by the higher-layer parameter msg1-FrequencyStart in SIB1, and the number of consecutive PRACH occasions FDMed in one time instance is configured by the higher-layer parameter msg1-FDM in SIB1. The number of PRACH occasions FDMed in one time domain PRACH occasion, can be 1, 2, 4, or 8.

Here the msg1-FDM and msg1-FrequencyStart are defined in 3GPP TS 38.331 as below: msg1-FDM: The number of PRACH transmission occasions FDMed in one time instance. msg1-FrequencyStart: Offset of lowest PRACH transmission occasion in frequency domain with respective to Physical Resource Block (PRB) 0. The value is configured so that the corresponding RACH resource is entirely within the bandwidth of the UL Bandwidth Part (BWP).

RACH-ConfigGeneric information element is shown below.

-- ASN1START
-- TAG-RACH-CONFIG-GENERIC-START

| | |
|---|---|
| RACH-ConfigGeneric ::= | SEQUENCE { |

| | |
|---|---|
| prach-ConfigurationIndex | INTEGER (0..255), |

| | |
|---|---|
| msg1-FDM | ENUMERATED {one, two, four, eight}, |
| msg1-FrequencyStart | INTEGER (0..maxNrofPhysicalResourceBlocks-1), |

| | |
|---|---|
| zeroCorrelationZoneConfig | INTEGER(0..15), |
| preambleReceivedTargetPower | INTEGER (−202..−60), |

| | |
|---|---|
| preambleTransMax | ENUMERATED {n3, n4, n5, n6, n7, n8, n10, n20, n50, |

n100, n200},

| | |
|---|---|
| powerRampingStep | ENUMERATED {dB0, dB2, dB4, dB6}, |
| ra-Response Window | ENUMERATED {sl1, sl2, sl4, sl8, sl10, sl20, sl40, sl80}, |

...
}
-- TAG-RACH-CONFIG-GENERIC-STOP
-- ASN1STOP

FIG. 3 illustrates an example of the PRACH occasion configuration in NR.

In NR Rel-15, there are up to 64 sequences that can be used as random-access preambles per PRACH occasion in each cell. The RRC parameter totalNumberOfRA-Preambles determines how many of these 64 sequences are used as random-access preambles per PRACH occasion in each cell. The 64 sequences are configured by including firstly all the available cyclic shifts of a root Zadoff-Chu sequence, and secondly in the order of increasing root index, until 64 preambles have been generated for the PRACH occasion.

### 2.1 NR Rel-15 Association Between SSB and PRACH Occasion

NR Rel-15 supports one-to-one, one-to-many, and many-to-one association between SSB and PRACH Occasions, as illustrated in FIGS. 4 and 5.

FIG. 4 shows an example of one SSB per PRACH occasion.

FIG. 5 shows an example with two SSBs per PRACH occasion.

The preambles associated to each SSB is configured by the two RRC parameters in the RACH-ConfigCommon: ssb-perRACH-OccasionAndCB-PreamblesPerSSB and totalNumberOfRA-Preambles.

The detailed mapping rule is specified in TS 38.213 section 8.1, as following:

For Type-1 random access procedure, a UE is provided a number N of SS/PBCH blocks associated with one PRACH occasion and a number R of contention based preambles per SS/PBCH block per valid PRACH occasion by ssb-perRACH-OccasionAndCB-PreamblesPerSSB.

A UE is provided a number N of SS/PBCH blocks associated with one PRACH occasion and a number R of contention-based preambles per SS/PBCH block per valid PRACH occasion by ssb-perRACH-OccasionAndCB-PreamblesPerSSB. If N<1, one SS/PBCH block is mapped to 1/N consecutive valid PRACH occasions and R contention based preambles with consecutive indexes associated with the SS/PBCH block per valid PRACH occasion start from preamble index 0. If N≥1, R contention based preambles with consecutive indexes associated with SS/PBCH block n, 0≤n≤N−1, per valid PRACH occasion start from preamble index n·N_{preamble}^{total}/N where N_{preamble}^{total} is provided by totalNumberOfRA-Preambles and is an integer multiple of N

SS/PBCH block indexes provided by ssb-PositionsInBurst in SIB1 or in ServingCellConfigCommon are mapped to valid PRACH occasions in the following order where the parameters are described in [4, TS 38.211].
First, in increasing order of preamble indexes within a single PRACH occasion
Second, in increasing order of frequency resource indexes for frequency multiplexed PRACH occasions
Third, in increasing order of time resource indexes for time multiplexed PRACH occasions within a PRACH slot
Fourth, in increasing order of indexes for PRACH slots

FIG. 6 shows an example of the mapping between SSBs and preambles in different PRACH occasions.

For each SSB, the associated preambles per PRACH occasion, N_{preamble}^{total}/N, are further divided into two sets for CBRA and CFRA. The number of CB preambles per SSB per PRACH occasion, R, is signaled by the RRC parameter ssb-perRACH-OccasionAndCB-PreamblesPerSSB. Preamble indices for CBRA and CFRA are mapped consecutively for one SSB in one PRACH occasion, as shown in FIG. 7.

If Random Access Preambles group B is configured for CBRA, then, amongst the CBRA preambles (#CB-preambles-per-SSB) associated with an SSB, the first numberOfRA-PreamblesGroupA Random Access Preambles belong to Random Access Preambles group A, and the remaining Random Access Preambles associated with the SSB belong to Random Access Preambles group B. FIG. 8 shows an example, when Random Access Preambles group B is configured for CBRA.

According to TS 38.213, one of the two conditions must be met in order for a UE to select Random Access Preambles group B for PRACH transmission:

Condition 1: potential Msg3 size (UL data available for transmission plus MAC header and, where required, MAC CEs) is greater than ra-Msg3SizeGroupA and the pathloss is less than PCMAX (of the Serving Cell performing the Random Access Procedure)—preambleReceivedTargetPower—msg3-DeltaPreamble—message PowerOffsetGroupB; or

Condition 2: the Random Access procedure was initiated for the CCCH logical channel and the CCCH SDU size plus MAC subheader is greater than ra-Msg3SizeGroupA.

FIG. 8 illustrates associated preambles for CBRA and CFRA per SSB per PRACH occasion when Random Access Preambles group B is configured.

### 3. RRC Establishment Cause for UE Differentiation

In step 3 of the 4-step random access procedure, a UE includes the rrcSetupRequest message in Msg3. The rrcSetupRequest message contains the parameter, establishmentCause. which indicates the establishment cause that triggers the connection establishment, e.g., emergency call, mission critical services, multimedia priority services, etc.

A gNB identifies the type of connection request from the UE by decoding the establishment cause received in msg3, based on which, the gNB decides whether this request shall be admitted or rejected, based on the network traffic load situation and available resource in the network.

### 4. NR Rel-16 for MsgA Configuration

### 4.1 MsgA Preamble Configuration

The RACH occasions for 2-step RACH can be either separately configured (also known as Type-2 random access procedure with separate configuration of PRACH occasions with Type-1 random access procedure) or are shared with 4-step RACH (also known as Type-2 random access procedure with common configuration of PRACH occasions with Type-1 random access procedure) in which case different set of preamble IDs will be used.

For Type-2 random access procedure with common configuration of PRACH occasions with Type-1 random access procedure, a UE is provided a number N of SS/PBCH blocks associated with one PRACH occasion by ssb-perRACH-OccasionAndCB-PreamblesPerSSB and a number Q of contention based preambles per SS/PBCH block per valid PRACH occasion by msgA-CB-PreamblesPerSSB. The PRACH transmission can be on a subset of PRACH occasions associated with a same SS/PBCH block index for a UE provided with a PRACH mask index by msgA-ssb-sharedRO-MaskIndex. An example of the SSB to RO mapping and the preamble allocation is provided in FIG. 9. Note that only one preamble group is assumed in this example.

FIG. 9 illustrates associated preambles for CBRA and CFRA per SSB per PRACH occasion when ROs for 2-step RACH and 4-step RACH are shared.

For Type-2 random access procedure with separate configuration of PRACH occasions with Type-1 random access procedure, a UE is provided a number N of SS/PBCH blocks associated with one PRACH occasion and a number R of contention based preambles per SS/PBCH block per valid PRACH occasion by ssb-perRACH-OccasionAndCB-PreamblesPerSSB-msgA when provided; otherwise, by ssb-perRACH-OccasionAndCB-PreamblesPerSSB. Since the SSB to RO mapping and the preamble allocation are independently configured, the example provided for 4-step RACH in FIG. 8 is also valid for this case of 2-step RACH except that the parameters are separately configured for 2-step RACH.

### SUMMARY

Mission critical (MC) services require coverage that is beyond what is typically needed for commercial services. In addition, in high load situations, the network should prioritize the access requests from UEs configured to provide MC services over the access requests from normal UEs.

Since message 1 shown in FIG. 1 or message A shown in FIG. 2 is the first message transmitted from a UE during the initial procedure, it is important to ensure the robustness of message 1 or message A transmissions from MC UEs.

In NR Rel-16, the prioritized random access feature was introduced for MC UEs. In particular, if a MC UE detects a Msg2 but fails to find the corresponding random access response matched to its random-access preamble transmission, then, the MC UE can send a new access attempt with a shorter waiting time (i.e., back-off time) and a larger preamble power ramping step size, compared to normal UEs. This feature can increase the likelihood of a faster successful completion of random access for MC UEs, but it can only be used after at least one access attempt failure.

Currently, there is no solution for proactively enhancing the robustness and/or coverage of message 1 (in FIG. 1) or message A (shown in FIG. 2) transmitted from MC UEs.

Some embodiments of this disclosure provide methods of how to enable, configure, and/or design first message (PRACH) repetition in random access for UEs configured to provide mission critical (MC) services (herein after, MC UEs). A MC UE is capable of performing initial first message transmission based on the signalling information received from the network node.

Accordingly, in one aspect, there is provided a method of configuring user equipments (UEs) to repeatedly transmit a first message while a repetition condition is met. The method comprises including in a second message a repetition parameter, wherein the repetition parameter indicates that a UE receiving the second message including the repetition parameter is allowed to or must transmit the first message repeatedly while the repetition condition is met if one or more criteria are met. The method further comprises transmitting the second message.

In another aspect, there is provided a method of configuring a user equipment (UE) to repeatedly transmit a first message while a repetition condition is met. The method comprises receiving a second message including a repetition parameter, wherein the repetition parameter indicates that a UE receiving the second message including the repetition parameter is allowed to or must transmit the first message repeatedly while the repetition condition is met if one or more criteria are met. The method further comprises based on the received second message, determining whether to repeatedly transmit the first message, and transmitting the first message.

In another aspect, there is provided a computer program comprising instructions which when executed by processing circuitry cause the processing circuitry to perform the method described above.

In another aspect, there is provided a base station for configuring user equipments (UEs) to repeatedly transmit a first message while a repetition condition is met. The base station is configured to include in a second message a repetition parameter, wherein the repetition parameter indicates that a UE receiving the second message including the repetition parameter is allowed to or must transmit the first message repeatedly while the repetition condition is met if one or more criteria are met. The base station is further configured to transmit the second message.

In another aspect, there is provided a user equipment (UE) for repeatedly transmitting a first message while a repetition condition is met. The UE is configured to receive a second message including a repetition parameter, wherein the repetition parameter indicates that a UE receiving the second message including the repetition parameter is allowed to or must transmit the first message repeatedly while the repetition condition is met if one or more criteria are met. The UE is further configured to based on the received second message, determine whether to repeatedly transmit the first message, and transmit the first message.

In another aspect, there is provided an apparatus comprising a memory and processing circuitry coupled to the memory, wherein the apparatus is configured to perform the method described above.

In another aspect, there is provided an apparatus comprising a memory and processing circuitry coupled to the memory, wherein the apparatus is configured to perform the method described above.

As described above, embodiments of this disclosure provide methods of enabling and/or configuring first message repetition for MC UEs. The first message repetition can improve network coverage and robustness of PRACH transmissions, thereby improving rate successfully and reducing latency for connection setup for MC UEs.

In addition, in case the same PRACH resources are shared between MC UEs and normal UEs and both types of UEs can perform PRACH repetition, methods of some embodiments of this disclosure can be used to allow PRACH repetition only for MC UEs in order to prioritize the random access for MC UEs.

### BRIEF DESCRIPTION OF THE DRAWINGS

The accompanying drawings, which are incorporated herein and form part of the specification, illustrate various embodiments.

FIG. 1 shows a four-step random access procedure for initial access.

FIG. 2 shows a two-step random access procedure for initial access.

FIG. 3 illustrates PRACH configuration in NR.

FIG. 4 shows one SSB per PRACH occasion.

FIG. 5 shows 2 SSBs per PRACH occasion.

FIG. 6 shows mappings between SSB and random-access preambles.

FIGS. 7-9 illustrate preambles for CBRA and CFRA.

FIG. 10 shows a process according to some embodiments.

FIG. 11 shows a process according to some embodiments.

FIG. 12 shows a base station according to some embodiments.

FIG. 13 shows a UE according to some embodiments.

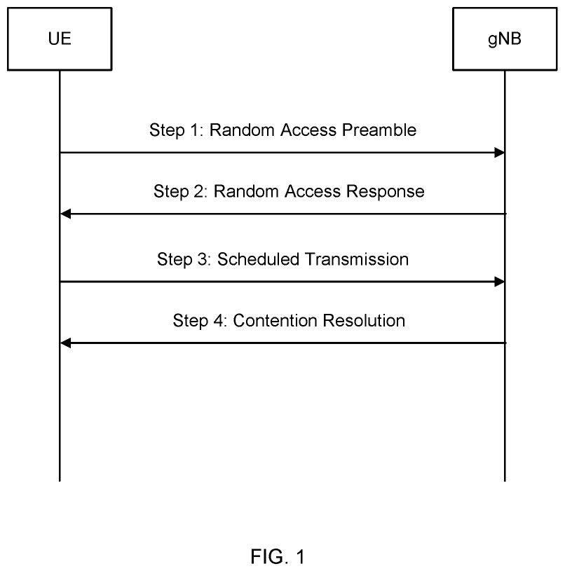

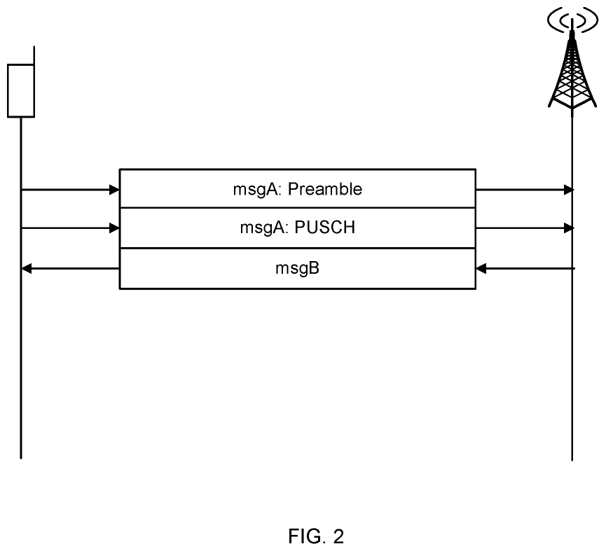

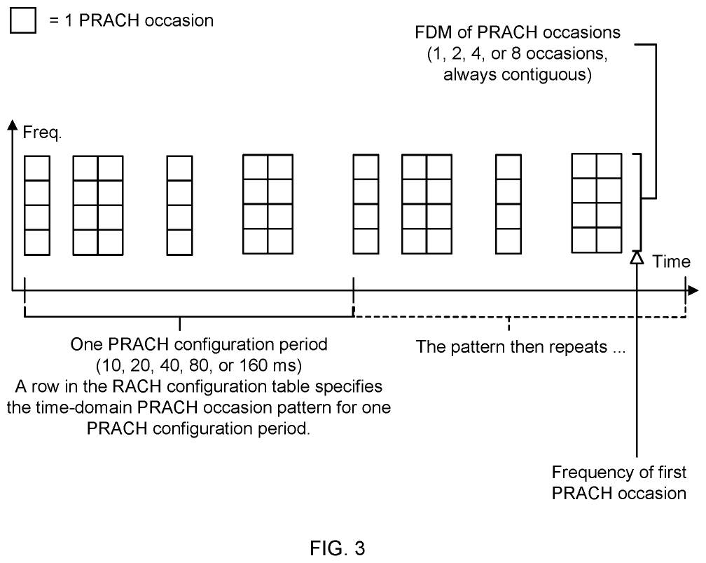

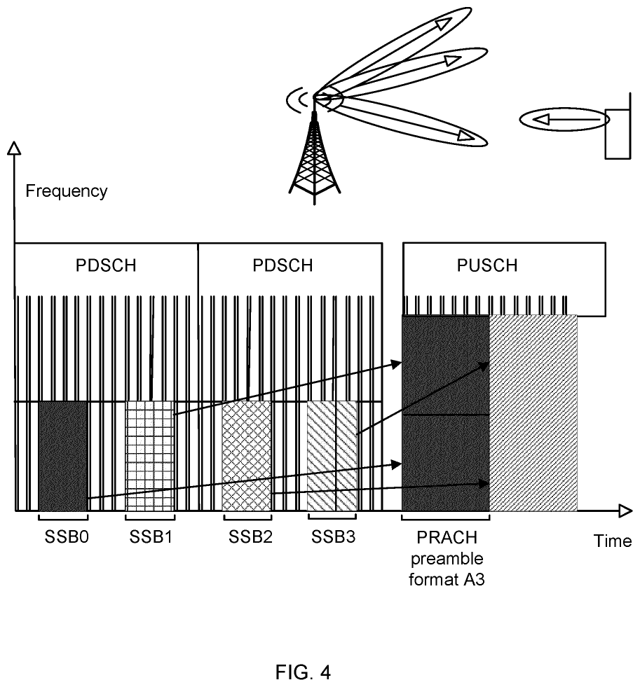

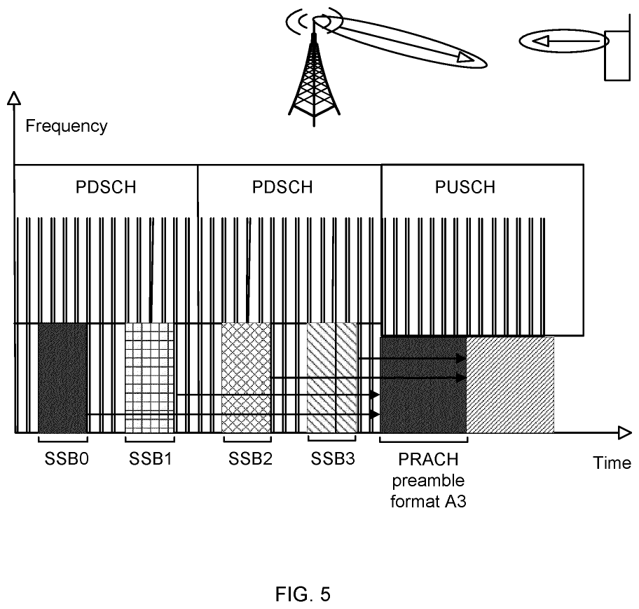

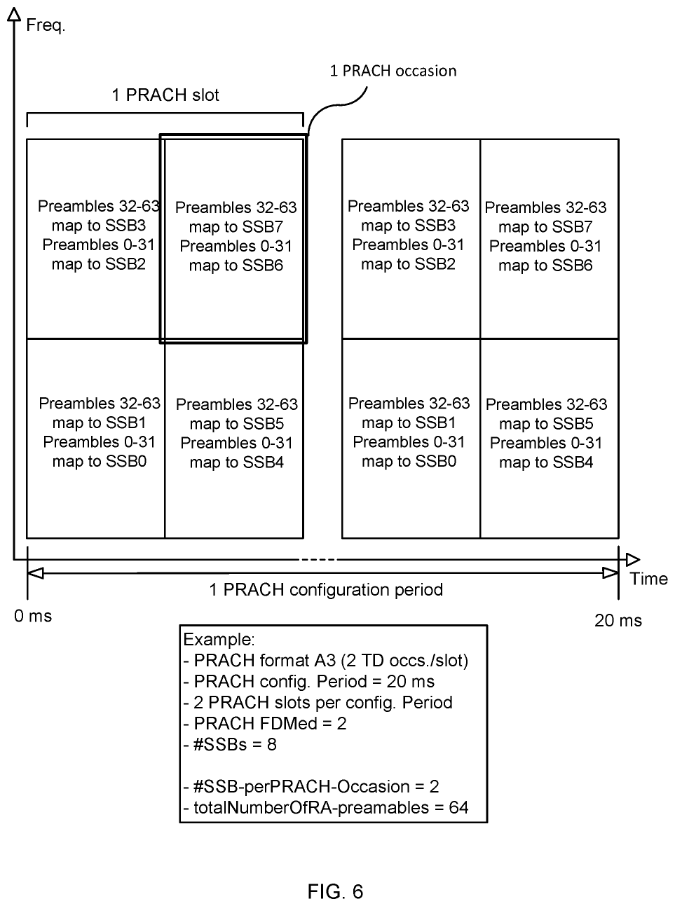

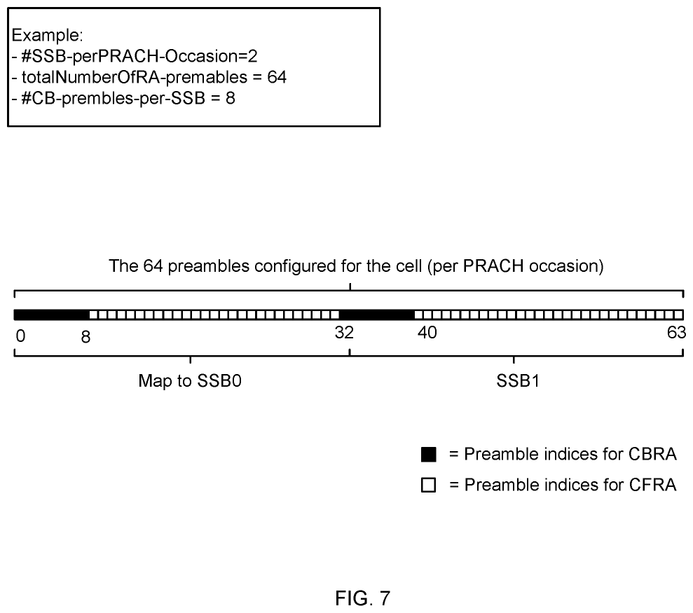

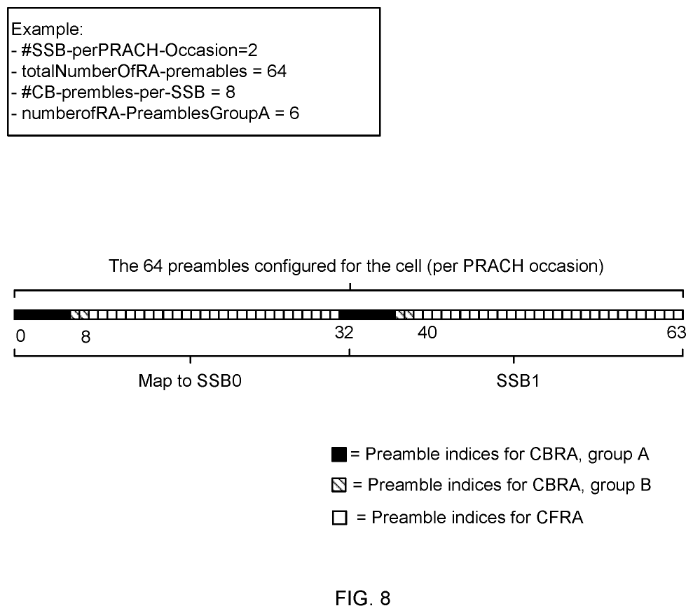

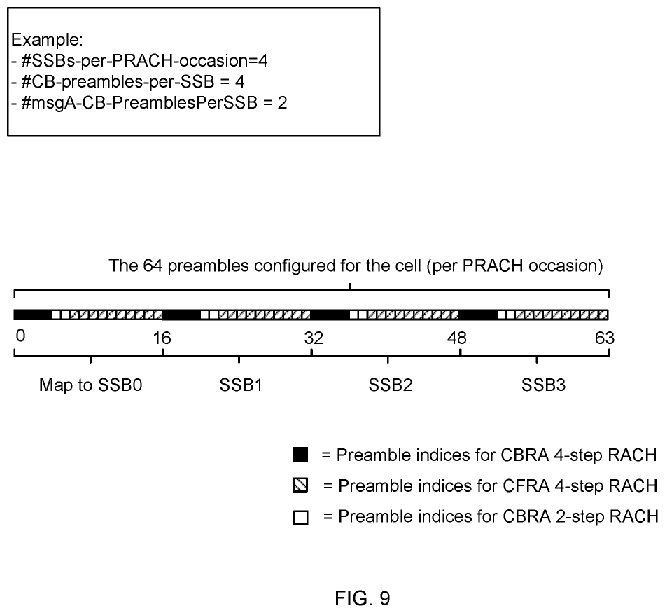

### DETAILED DESCRIPTION

Some embodiments of this disclosure provide methods for configuring, prioritizing, and/or supporting the first message repetition (i.e., a repeated transmission of the first message) for particular type(s) of UEs such as MC UEs, UEs configured with multimedia priority service(s), etc.

In this disclosure, the transmission of the “first message” may be a Msg1 transmission in 4-step RACH or a MsgA or MsgA PRACH transmission in 2-step RACH. Also the “first message repetition” may mean multiple PRACH transmissions before the end of RAR window and/or multiple PRACH transmissions from one UE before PRACH reattempt happens.

In some embodiments, the first message repetition may be multiple PRACH transmissions with the same PRACH preambles. But in other embodiments, the first message repetition may be multiple PRACH transmission with different PRACH preambles. The PRACH may be transmitted with the same transmit (TX) beam or different TX beams.

In this disclosure, the “PRACH resources” may be PRACH resources in time or frequency domain or different PRACH preamble sequences.

Embodiments of this disclosure provide methods of enabling the first message repetition for particular type(s) of UEs (e.g., MC UEs, UEs configured with multimedia priority services, etc.). For simplicity, in the rest of this disclosure, MC UEs will be used as an example of the particular type of UEs.

In some embodiments, the first message repetition may be configured with one or more of the following options: (1) the first message repetition may be configured in System Information (SI) (e.g., in the RACH-ConfigCommon IE in SIB1); (2) the first message repetition may be associated with a particular UE access identity; (3) the first message repetition may be associated with a particular access category; (4) PRACH repetition determination may be based on UE's capability of supporting the first message repetition; and (5) PRACH repetition determination may be based on the measurement from a reference signal (e.g., RSRP, RSRQ, RSSI, or SINR).

For example, in a four-step contention-based random access (CBRA), a first message repetition parameter may be included in ra-Prioritization ForAccessIdentity in the RACH-ConfigCommon IE in SIB1. The parameter may be associated with a specific set of access identities (e.g., access identity 1—UEs configured with multimedia priority services—and/or access identity 2—UEs configured with MC services). If the first message repetition parameter is present in SIB1, a UE configured with the specific set of access identities must perform MsgA (PRACH) repetition when transmitting MsgA in the 2-step CBRA. The first message repetition parameter may additionally indicate the number of the repetition.

As another example, in a two-step contention-based random access (CBRA), a first message repetition parameter may be included in ra-Prioritization ForAccessIdentityTwoStep in the RACH-ConfigCommon IE in SIB1. The parameter may be associated with a specific set of access identities (e.g., access identity 1—UEs configured with multimedia priority services—and/or access identity 2—UEs configured with MC services). If the first message repetition parameter is present in SIB1, a UE configured with the specific set of access identities must perform MsgA (PRACH) repetition when transmitting MsgA in the 2-step CBRA. The first message repetition parameter may additionally indicate the number of the repetition.

In another example, when the PRACH repetition configuration is enabled in SIB1, a MC UE may decide whether to use PRACH repetition based on the MC UE's capability of supporting the PRACH repetition and/or whether the RSRP, RSRQ, and/or RSSI measured on a downlink reference signal (e.g., the RS for pathloss estimation) is below or not larger than a configured or predetermined threshold.

In some embodiments, the first message repetition may be associated with a specific set of PRACH resources that are dedicated for MC UEs. Here, a PRACH resource may be a time-frequency PRACH occasion or a random-access preamble index. For example, if dedicated PRACH resources are configured for MC UEs, then the MC UEs may always perform Msg1 repetition when using these resources if certain criteria are met. The number of the repetitions may be indicated by the number of consecutive PRACH occasions configured in the time domain.

In some embodiments, the first message repetition for MC UEs may be associated with a subset of a specific set of PRACH resources that are dedicated for UEs requesting PRACH repetition. For example, a separate set of PRACH resources may be configured for UEs supporting PRACH repetition. In such case, a subset of this separate set of PRACH resources may be reserved for MC UEs supporting PRACH repetition and the remaining PRACH resources may be used by normal UEs supporting PRACH repetition.

In some embodiments, MC UEs may be configured to always support the first message repetition. But there may be a scenario where some MC UEs may not have capabilities to support the first message repetition. Thus, in some embodiments, MC UEs may be configured to support the first message repetition based on MC UEs' capabilities. Alternatively or additionally, in some embodiments, even if a MC UE supports the first message repetition, the MC UE may be configured to select first message transmission without repetition.

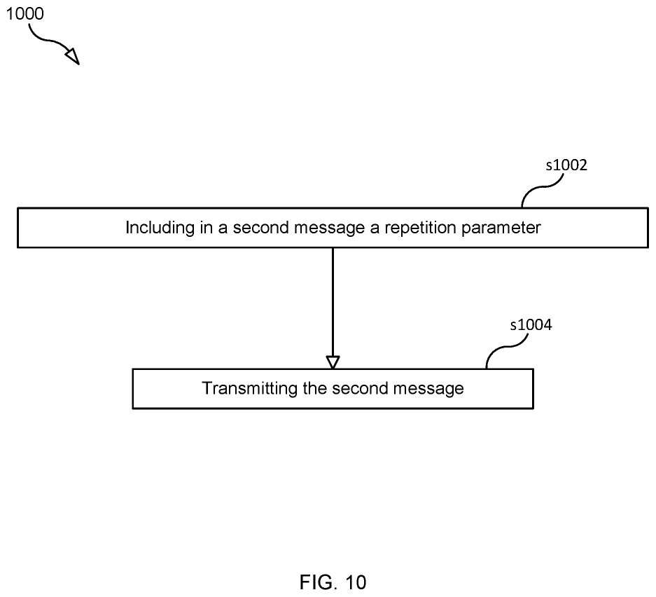

FIG. 10 shows a process 1000 according to some embodiments. Process 1000 is for configuring UEs to repeatedly transmit a first message while a repetition condition is met. Process 1000 may be performed by a base station such as gNB and may begin with step s1002. Step s1002 comprises including in a second message a repetition parameter. The repetition parameter indicates that a UE receiving the second message including the repetition parameter is allowed to or must transmit the first message repeatedly while the repetition condition is met if one or more criteria are met. Step s1004 comprises transmitting the second message.

In some embodiments, the first message includes random access preamble.

In some embodiments, the repetition condition is that (i) a random access response (RAR) window has not been ended and/or (ii) physical random access channel (PRACH) reattempt has not occurred.

In some embodiments, the second message is a broadcast message, and the repetition parameter is included in system information block (SIB) of the broadcast message.

In some embodiments, said one or more criteria includes that the UE receiving the second message is (i) a UE configured with a mission critical (MC) service, (ii) a UE configured with multimedia priority services, or (iii) any one of (i) and (ii).

In some embodiments, said one or more criteria is associated with one or more UE capabilities.

In some embodiments, said one or more UE capabilities includes i) a capability of repeatedly transmitting Msg1, Msg3, and/or MsgA, and/or ii) beamforming related capability.

Examples of the beamforming related capability include the capability of transmitting Msg1, Msg3, and/or MsgA using a wide beam and/or a narrow beam, the capability of performing an analog beamforming and/or a digital beamforming, the capability of performing a beam sweeping for Msg1, Msg3, and/or MsgA transmissions, the capability of using a higher transmit power for Msg1, Msg3, and/or MsgA transmissions, the number of narrow beams per a UE panel, etc.

In some embodiments, said one or more UE capabilities may be defined per frequency range (e.g., FR1, FR2), frequency band, cell, or bandwidth part. In some embodiments, the related UE capabilities may be associated with a specific feature such as, for example, random access procedure during initial access, random access procedure for beam failure recovery, random access procedure for link failure recovery, or/and random access procedure for handover.

In some embodiments, said one or more criteria is associated with one or more UE capabilities.

In some embodiments, said one or more UE capabilities includes i) a capability of repeatedly transmitting Msg1, Msg3, and/or MsgA, and/or ii) beamforming related capability. Msg1, Msg3, and MsgA are defined in 3GPP TS 38.213, Section 8.

In some embodiments, said one or more criteria includes that a measurement of a downlink reference signal is below or not larger than a predetermined threshold.

In some embodiments, the repetition parameter further indicates the number of allowed or required repeated transmissions of the first message.

In some embodiments, a particular group of PRACH resources are assigned for repeated transmission of the first message for the UEs.

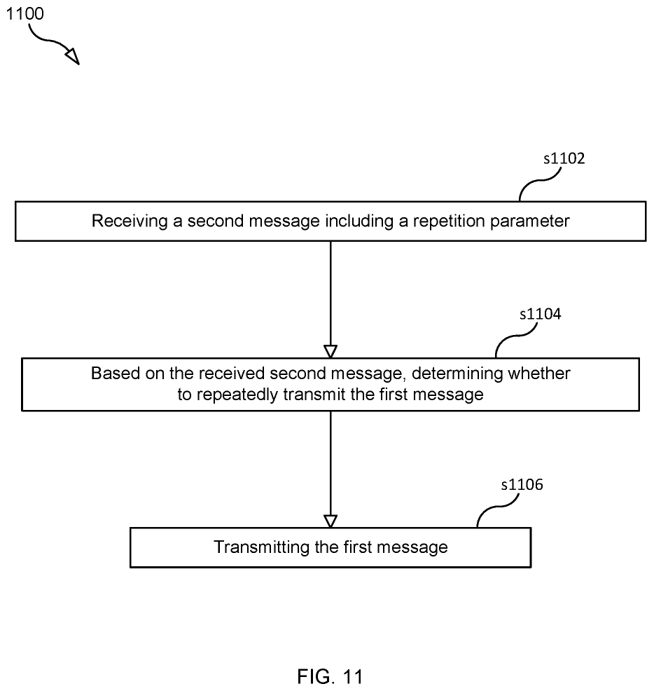

FIG. 11 shows a process 1100 according to some embodiments. Process 1100 is for configuring a user equipment (UE) to repeatedly transmit a first message while a repetition condition is met. Process 1100 may begin with step s1102. Step s1102 comprises receiving a second message including a repetition parameter. The repetition parameter indicates that a UE receiving the second message including the repetition parameter is allowed to or must transmit the first message repeatedly while the repetition condition is met if one or more criteria are met. Step s1104 comprises based on the received second message, determining whether to repeatedly transmit the first message. Step s1106 comprises transmitting the first message.

In some embodiments, the first message includes random access preamble.

In some embodiments, the repetition condition is that (i) a random access response (RAR) window has not been ended and/or (ii) physical random access channel (PRACH) reattempt has not occurred.

In some embodiments, the second message is a broadcast message, and the repetition parameter is included in system information block (SIB) of the broadcast message.

In some embodiments, said one or more criteria includes that the UE receiving the second message is (i) a UE configured to provide a mission critical (MC) service, (ii) a UE configured to provide multimedia priority services, or (iii) any one of (i) and (ii).

In some embodiments, said one or more criteria is associated with one or more UE capabilities.

In some embodiments, said one or more UE capabilities includes i) a capability of repeatedly transmitting Msg1, Msg3, and/or MsgA, and/or ii) beamforming related capability.

Examples of the beamforming related capability include the capability of transmitting Msg1, Msg3, and/or MsgA using a wide beam and/or a narrow beam, the capability of performing an analog beamforming and/or a digital beamforming, the capability of performing a beam sweeping for Msg1, Msg3, and/or MsgA transmissions, the capability of using a higher transmit power for Msg1, Msg3, and/or MsgA transmissions, the number of narrow beams per a UE panel, etc.

In some embodiments, said one or more UE capabilities may be defined per frequency range (e.g., FR1, FR2), frequency band, cell, or bandwidth part. In some embodiments, the related UE capabilities may be associated with a specific feature such as, for example, random access procedure during initial access, random access procedure for beam failure recovery, random access procedure for link failure recovery, or/and random access procedure for handover.

In some embodiments, the method further comprises receiving a downlink reference signal, and said one or more criteria includes that a measurement of the downlink reference signal is below or not larger than a predetermined threshold.

In some embodiments, the repetition parameter further indicates the number of allowed or required repeated transmissions of the first message.

In some embodiments, a particular group of PRACH resources are assigned for repeated transmission of the first message.

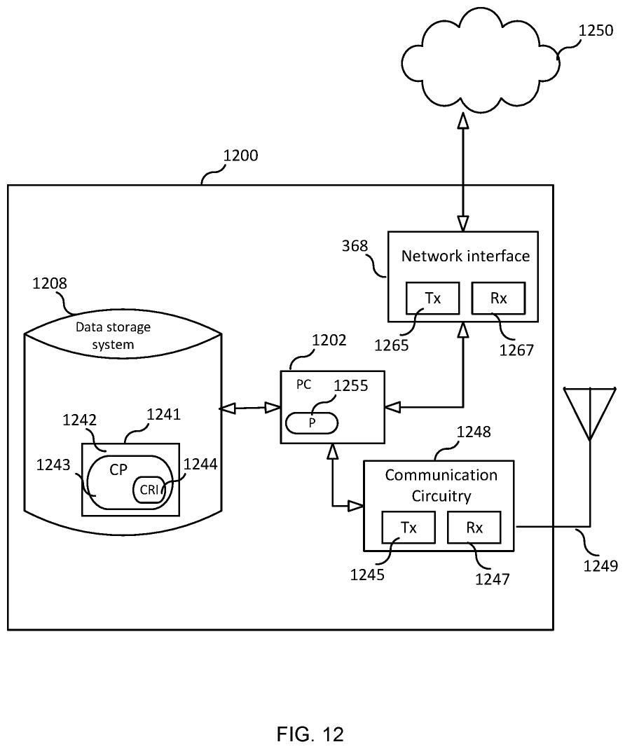

Referring now to FIG. 12, FIG. 12 is a block diagram of a network node (e.g., a base station such as gNB), according to some embodiments. As shown in FIG. 12, apparatus 1200 may comprise: processing circuitry (PC) 1202, which may include one or more processors (P) 1255 (e.g., one or more general purpose microprocessors and/or one or more other processors, such as an application specific integrated circuit (ASIC), field-programmable gate arrays (FPGAs), and the like), which processors may be co-located in a single housing or in a single data center or may be geographically distributed (i.e., apparatus 1200 may be a distributed computing apparatus); a network interface 1268 comprising a transmitter (Tx) 1265 and a receiver (Rx) 1267 for enabling apparatus 1200 to transmit data to and receive data from other nodes connected to a network 1250 (e.g., an Internet Protocol (IP) network) to which network interface 1268 is connected; communication circuitry 1248, which is coupled to an antenna arrangement 1249 comprising one or more antennas and which comprises a transmitter (Tx) 1245 and a receiver (Rx) 1247 for enabling apparatus 1200 to transmit data and receive data (e.g., wirelessly transmit/receive data); and a local storage unit (a.k.a., “data storage system”) 1208, which may include one or more non-volatile storage devices and/or one or more volatile storage devices. In embodiments where PC 1202 includes a programmable processor, a computer program product (CPP) 1241 may be provided. CPP 1241 includes a computer readable medium (CRM) 1242 storing a computer program (CP) 1243 comprising computer readable instructions (CRI) 1244. CRM 1242 may be a non-transitory computer readable medium, such as, magnetic media (e.g., a hard disk), optical media, memory devices (e.g., random access memory, flash memory), and the like. In some embodiments, the CRI 1244 of computer program 1243 is configured such that when executed by PC 1202, the CRI causes apparatus 1200 to perform steps described herein (e.g., steps described herein with reference to the flow charts). In other embodiments, apparatus 1200 may be configured to perform steps described herein without the need for code. That is, for example, PC 1202 may consist merely of one or more ASICs. Hence, the features of the embodiments described herein may be implemented in hardware and/or software.

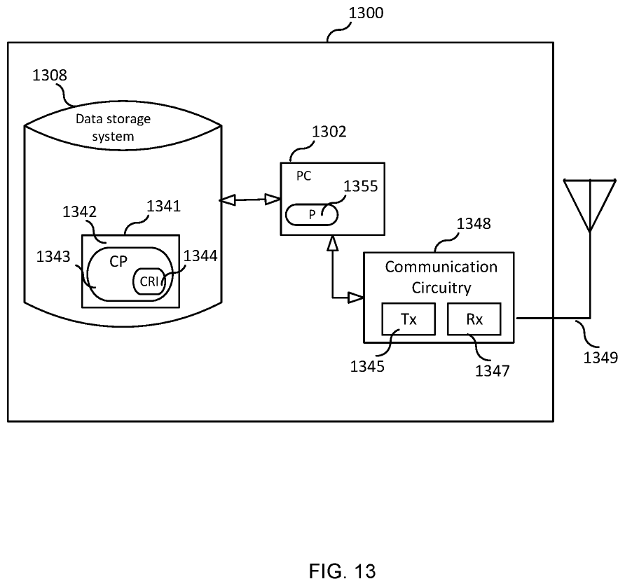

Referring now to FIG. 13, FIG. 13 is a block diagram of a UE, according to some embodiments. As shown in FIG. 13, a UE may comprise: processing circuitry (PC) 1302, which may include one or more processors (P) 1355 (e.g., one or more general purpose microprocessors and/or one or more other processors, such as an application specific integrated circuit (ASIC), field-programmable gate arrays (FPGAs), and the like); communication circuitry 1348, which is coupled to an antenna arrangement 1349 comprising one or more antennas and which comprises a transmitter (Tx) 1345 and a receiver (Rx) 1347 for enabling the UE to transmit data and receive data (e.g., wirelessly transmit/receive data); and a local storage unit (a.k.a., “data storage system”) 1308, which may include one or more non-volatile storage devices and/or one or more volatile storage devices. In embodiments where PC 3202 includes a programmable processor, a computer program product (CPP) 1341 may be provided. CPP 1341 includes a computer readable medium (CRM) 1342 storing a computer program (CP) 1343 comprising computer readable instructions (CRI) 1344. CRM 1342 may be a non-transitory computer readable medium, such as, magnetic media (e.g., a hard disk), optical media, memory devices (e.g., random access memory, flash memory), and the like. In some embodiments, the CRI 1344 of computer program 1343 is configured such that when executed by PC 1302, the CRI causes the UE to perform steps described herein (e.g., steps described herein with reference to the flow charts). In other embodiments, the UE may be configured to perform steps described herein without the need for code. That is, for example, PC 1302 may consist merely of one or more ASICs. Hence, the features of the embodiments described herein may be implemented in hardware and/or software.

While various embodiments are described herein, it should be understood that they have been presented by way of example only, and not limitation. Thus, the breadth and scope of this disclosure should not be limited by any of the above described exemplary embodiments. Moreover, any combination of the above-described elements in all possible variations thereof is encompassed by the disclosure unless otherwise indicated herein or otherwise clearly contradicted by context.

Additionally, while the processes and message flows described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

1-27. (canceled)

28. A method of configuring one or more user equipments, UEs, to repeatedly transmit a first message while a repetition condition is met, characterized by:
including in a second message a repetition parameter, wherein the repetition parameter indicates that a UE receiving the second message including the repetition parameter is allowed to or must transmit the first message repeatedly while the repetition condition is met if one or more criteria are met; and
transmitting the second message, wherein
the repetition condition is that physical random access channel, PRACH, reattempt has not occurred, and
said one or more criteria includes that the UE receiving the second message is (i) a UE configured to provide a mission critical, MC, service, (ii) a UE configured to provide one or more multimedia priority services, or (iii) any one of (i) and (ii).

29. The method of claim 28, wherein the first message includes random access preamble.

30. The method of claim 28, wherein the repetition condition is also that a random access response, RAR, window has not been ended.

31. The method of claim 28, wherein
the second message is a broadcast message, and
the repetition parameter is included in system information block, SIB, of the broadcast message.

32. The method of claim 28, wherein said one or more criteria is associated with one or more UE capabilities.

33. The method of claim 32, wherein said one or more UE capabilities includes i) a capability of repeatedly transmitting Msg1, Msg3, and/or MsgA, and/or ii) beamforming related capability.

34. The method of claim 28, wherein said one or more criteria includes that a measurement of a downlink reference signal is below or not larger than a predetermined threshold.

35. The method of claim 28, wherein the repetition parameter further indicates the number of allowed or required repeated transmissions of the first message.

36. The method of claim 28, wherein
a particular group of PRACH resources is dedicated for repeated transmission of the first message for the UEs.

37. A method of configuring a user equipment, UE, to repeatedly transmit a first message while a repetition condition is met, characterized by:
receiving a second message including a repetition parameter, wherein the repetition parameter indicates that a UE receiving the second message including the repetition parameter is allowed to or must transmit the first message repeatedly while the repetition condition is met if one or more criteria are met;
based on the received second message, determining whether to repeatedly transmit the first message; and
transmitting the first message, wherein
the repetition condition is that physical random access channel, PRACH, reattempt has not occurred, and
said one or more criteria includes that the UE receiving the second message is (i) a UE configured to provide a mission critical, MC, service, (ii) a UE configured to provide one or more multimedia priority services, or (iii) any one of (i) and (ii).

38. The method of claim 37, wherein the first message includes random access preamble.

39. The method of claim 37, wherein the repetition condition is also that a random access response, RAR, window has not been ended.

40. The method of claim 37, wherein
the second message is a broadcast message, and
the repetition parameter is included in system information block, SIB, of the broadcast message.

41. The method of claim 37, wherein said one or more criteria is associated with one or more UE capabilities.

42. The method of claim 41, wherein said one or more UE capabilities includes i) a capability of repeatedly transmitting Msg1, Msg3, and/or MsgA, and/or ii) beamforming related capability.

43. The method of claim 37, wherein
the method further comprises receiving a downlink reference signal, and
said one or more criteria includes that a measurement of the downlink reference signal is below or not larger than a predetermined threshold.

44. The method of claim 37, wherein the repetition parameter further indicates the number of allowed or required repeated transmissions of the first message.

45. The method of claim 37, wherein a particular group of PRACH resources is dedicated for repeated transmission of the first message.

46. A base station for configuring one or more user equipments, UEs, to repeatedly transmit a first message while a repetition condition is met, the base station comprising:
a memory; and
processing circuitry coupled to the memory, wherein the base station is configured to:
include in a second message a repetition parameter, wherein the repetition parameter indicates that a UE receiving the second message including the repetition parameter is allowed to or must transmit the first message repeatedly while the repetition condition is met if one or more criteria are met; and
transmit the second message, wherein
the repetition condition is that physical random access channel, PRACH, reattempt has not occurred, and
said one or more criteria includes that the UE receiving the second message is (i) a UE configured to provide a mission critical, MC, service, (ii) a UE configured to provide one or more multimedia priority services, or (iii) any one of (i) and (ii).

47. A user equipment, UE, for repeatedly transmitting a first message while a repetition condition is met, the UE comprising:
a memory; and
processing circuitry coupled to the memory, wherein the UE is configured to:
receive a second message including a repetition parameter, wherein the repetition parameter indicates that a UE receiving the second message including the repetition parameter is allowed to or must transmit the first message repeatedly while the repetition condition is met if one or more criteria are met;
based on the received second message, determine whether to repeatedly transmit the first message; and
transmit the first message, wherein
the repetition condition is that physical random access channel, PRACH, reattempt has not occurred, and
said one or more criteria includes that the UE receiving the second message is (i) a UE configured to provide a mission critical, MC, service, (ii) a UE configured to provide one or more multimedia priority services, or (iii) any one of (i) and (ii).
